(19) United States
(12) Patent Application Publication
(10) Pub. No.: US 2004/0012726 A1
(43) Pub. Date: Jan. 22, 2004

(54) Active matrix display device

(75) Inventors: Mitsuru Kano, Fukushima-ken (JP); Katsumasa Yoshii, Fukushima-ken (JP); Yuzo Hayashi, Fukushima-ken (JP); Hiroyuki Hebiguchi, Fukushima-ken (JP); Masahiko Yamaguchi, Fukushima-ken (JP)

Correspondence Address: Brinks Hofer Gilson & Lione, P.O. Box 10395, Chicago, IL, 60610, US

(73) Assignee: ALPS Electric Co., Ltd.

(21) Appl. No.: 10/622,044

(22) Filed: Jul. 16, 2003

(30) Foreign Application Priority Data
Jul. 18, 2002 (JP) 2002-209749

(51) Int. Cl. G02F 1/136

(52) U.S. Cl. 349/43

(57) ABSTRACT

A drain electrode of each TFT has an extension extending to the scanning line side or the signal line side, and contact holes are formed above the extension. In this case, the contact holes are arranged along scanning lines. In a plan view, the contact holes are masked with a shielding layer of a color filter layer provided on a counter substrate.

### BACKGROUND OF THE INVENTION

1. Field of the Invention

The present invention relates to an active matrix display device suitably used as a reflective display device using external light reflection for a display.

2. Description of the Related Art

In the field of display devices, an active matrix display device capable of obtaining a high-quality display is widely used. In this display device, a switching element is provided for each of a plurality of pixel electrodes to perform secure switching, thereby easily achieving characteristics such as a large size, high precision, etc.

Recently, it has been strongly demanded to decrease power consumption, and to widen a pixel region as must as possible for improving display brightness. Therefore, a display device comprising a thick insulating film formed over the entire surface of an active matrix substrate, and reflective pixel electrodes formed on the insulating film has been put into practical use. In this structure comprising the pixel electrodes formed on the insulating film, an electrical short circuit does not occur between the pixel electrodes disposed on the insulating film and scanning lines and signal lines disposed below the insulating film. Thus, the pixel electrodes can be formed over a wide area so as to overlap with these wirings, and thus a pixel region contributing to a display can be formed over all regions other than regions for switching elements such as thin film transistors (abbreviated to “TFT” hereinafter), and the scanning lines and signal lines, thereby achieving a bright display due to an increased aperture ratio.

In the above-described structure in which the pixel electrodes are formed on the insulating film, contact between a source electrode and a reflective electrode of each of the TFTs is achieved through a contact hole passing through the insulating film in the thickness direction thereof. The contact hole is disposed in each of the pixel pitches, and thus a slight deviation occurs between a plurality of contact hole patterns in repeated patterning. However, in a reflective display device, light is scattered by recesses of the reflective electrodes formed along the shapes of the contact holes, and thus moire occurs due to the light scattering to possibly decrease visibility.

A reflective liquid crystal display device comprising a reflective electrode having an uneven surface which serves as a diffuse reflective surface is conventionally put into practical use. However, in the use of the reflective electrode having the diffuse reflective surface, a moire display is likely to be enhanced by the influence of the recesses of the reflective electrode formed along the shapes of the contact holes.

### SUMMARY OF THE INVENTION

The present invention has been achieved in consideration of the above problem, and an object of the present invention is to provide an active matrix display device capable of preventing the occurrence of moire due to contact holes.

In order to achieve the object, an active matrix display device of the present invention comprises an active matrix substrate which comprises a plurality of scanning lines, a plurality of signal lines intersecting the scanning lines, switching elements provided near the respective intersections of the scanning lines and the signal lines, an insulating layer having contact holes connected to the switching elements and covering the scanning lines, the signal lines and the switching elements, and pixel electrodes electrically connected to the switching elements through the contact holes formed in the insulating layer; a counter substrate having a counter electrode facing the pixel electrodes; and a light modulating layer held between the active matrix substrate and the counter substrate; wherein the contact holes are masked in a plan view.

In this construction, since the contact holes are masked in a plan view, the occurrence of moire due to the arrangement of the contact holes can be prevented.

Particularly, in a reflective display device comprising diffusively reflective electrodes used as pixel electrodes, visibility possibly significantly deteriorates due to the moire which is caused by great scattering in the contact holes. However, as described above, a high-quality display without moire can be obtained by shielding from light reflected by the contact holes. For example, the diffusively reflective electrodes are formed in light diffusion recesses formed in the insulating layer so that each of the electrode serves as the pixel electrode having a shape conforming to each recess.

In a plan view, the contact holes may be masked with a shielding layer formed on one of the active matrix substrate and the counter substrate. Specifically, a color filter layer is formed on one of the active matrix substrate and the counter substrate, and the color filter layer preferably comprises a plurality of color filters disposed corresponding to the respective pixel electrodes, and the shielding layer being preferably disposed between the adjacent color filters. In this case, a color display can be realized.

Also, a plurality of the contact holes is preferably arranged in the length direction of the scanning lines or signal lines. In this construction, contact resistance between the pixel electrodes and the switching elements can be decreased by the plurality of contact holes. Even when a contact defect occurs between the pixel electrode and switching element in one of the contact holes, conduction can be attained through the other contact holes, thereby improving production yield. Furthermore, since the contact holes are arranged in the length direction of the scanning lines or the signal lines, for example, when the contact holes are masked in a plan view with the shielding layer provided along the scanning lines or the signal lines, the area of the pixel electrodes masked with the light shielding layer is smaller than that in a case in which the contact holes are arranged in a direction perpendicular to the scanning lines or signal lines, thereby increasing the aperture ratio.

Each of the switching elements may be formed as a thin film transistor comprising a gate electrode extending from the corresponding scanning line, a gate insulating layer disposed on the gate electrode, a source electrode disposed on the gate insulating layer to extend from the corresponding signal line, and a drain electrode electrically connected to the pixel electrode through the contact holes formed in the gate insulating layer. In this case, the drain electrode preferably has an extension extending from a portion positioned above the gate electrode to the scanning line side or the signal line side so that the contact holes are connected to the extension.

In this construction, since the contact holes are formed to be connected to the extension extending to the scanning line side or the signal line side, for example, when the contact holes are masked in a plan view with the shielding layer provided along the scanning lines or signal lines, the area of the pixel electrodes masked with the shielding layer is small, thereby increasing the aperture ratio. In this case, only the extensions are disposed near the scanning lines or signal lines, and thus electrical characteristics less deteriorate due to capacity coupling between the drain electrodes and the scanning lines or signal lines.

### BRIEF DESCRIPTION OF THE DRAWINGS

FIG. 1 is a plan view showing an active matrix substrate and components formed thereon in a liquid crystal panel constituting an active matrix display device according to an embodiment of the present invention, as viewed from the counter substrate side;

FIG. 2 is a sectional view showing the entire configuration of the liquid crystal panel constituting the active matrix display device shown in FIG. 1, taken along line II-II′ in FIG. 1;

FIG. 3 is a perspective view showing the entire configuration of an active matrix display device according to an embodiment of the present invention;

FIG. 4 is a perspective view showing pixel electrodes of an active matrix substrate constituting an active matrix display device according to an embodiment of the present invention;

FIG. 5 is an enlarged sectional view illustrating the configuration of a pixel electrode according to an embodiment of the present invention;

FIG. 6 is a diagram showing the reflective characteristic of a pixel electrode according to an embodiment of the present invention;

FIG. 7 is a partial sectional view showing a front light constituting an active matrix display device according to an embodiment of the present invention;

FIG. 8 is a plan view showing a counter substrate of a liquid crystal panel constituting an active matrix display device according to an embodiment of the present invention, as viewed from the front light side;

FIG. 9 is an enlarged plan view showing a principal portion of an active matrix substrate constituting an active matrix display device according to a first modified embodiment of the present invention;

FIG. 10 is a perspective view showing a pixel electrode of an active matrix substrate constituting an active matrix display device according to a second modified embodiment of the present invention;

FIG. 11 is an enlarged sectional view illustrating the configuration of a pixel electrode of the second modified embodiment of the present invention;

FIG. 12 is a diagram showing the reflective characteristic of a pixel electrode of the second modified embodiment of the present invention;

FIG. 13 is a perspective view showing a pixel electrode of an active matrix substrate constituting an active matrix display device according to a third modified embodiment of the present invention;

FIG. 14 is an enlarged sectional view illustrating the configuration of a pixel electrode of the third modified embodiment of the present invention;

FIG. 15 is an enlarged sectional view illustrating the configuration of a pixel electrode of the third modified embodiment of the present invention; and

FIG. 16 is a diagram showing the reflective characteristic of a pixel electrode of the third modified embodiment of the present invention.

### DESCRIPTION OF THE PREFERRED EMBODIMENTS

A reflective liquid crystal display device as an example of an active matrix display device according to an embodiment of the present invention will be described below with reference to the drawings. In each of the drawings, the same portions as a conventional technique are denoted by the same reference numerals, and the description thereof is partially omitted. In all drawings, the thickness and dimensional ratio each of components are appropriately changed for the sake of easy seeing.

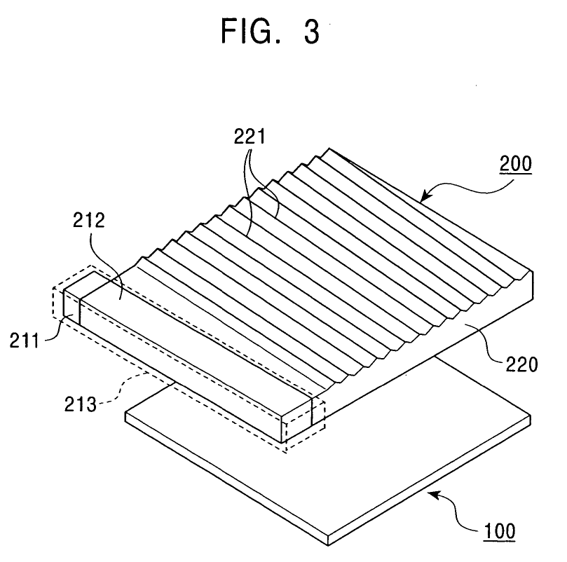

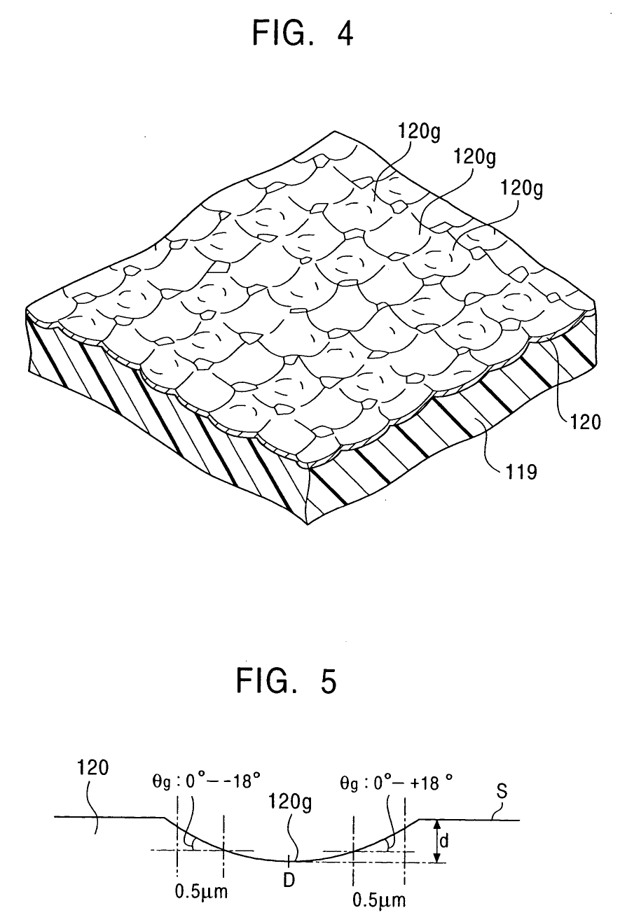

As shown in FIG. 3, the reflective liquid crystal display device of this embodiment comprises a liquid crystal panel 100 serving as a body, and a front light 200 disposed in front of the liquid crystal panel 100.

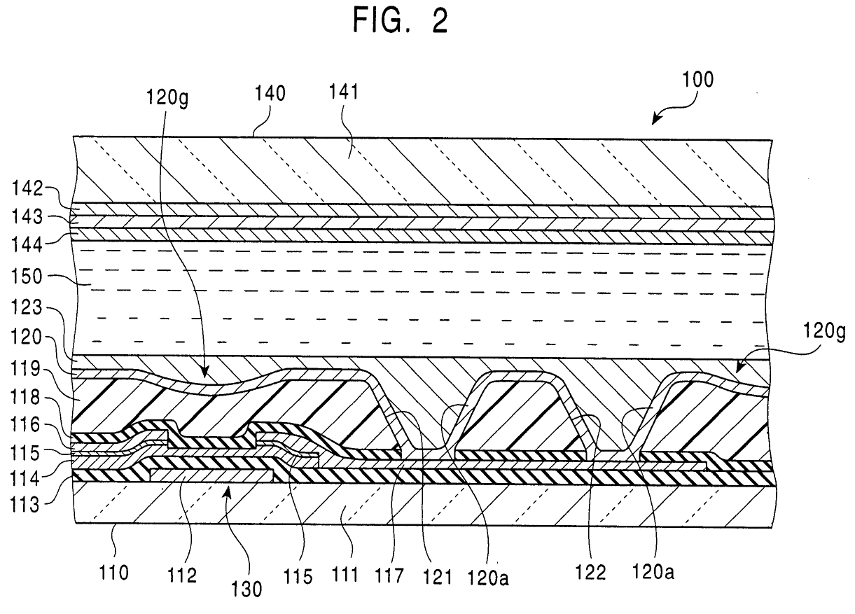

As shown in FIG. 2, the liquid crystal panel 100 comprises an active matrix substrate 110, a counter substrate 140, and a liquid crystal layer 150 serving as a light modulating layer held between both substrates 110 and 140.

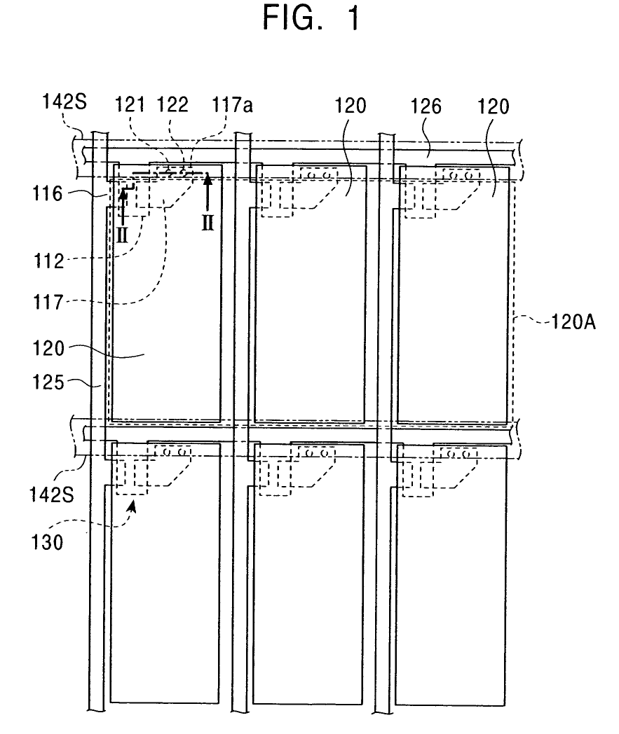

As shown in FIG. 1, the active matrix substrate 110 comprises pluralities of scanning lines 126 and signal lines 125 which are formed on a substrate body 111 made of glass, plastic or the like in the row direction (x-axis direction) and column direction (y-axis direction), respectively, so as to be electrically insulated from each other, a TFT (switching element) 130 being formed near each of the intersections of the scanning lines 126 and the signal lines 125. On the substrate 110, a region for forming the pixel electrodes 120, a region for forming the TFTs 30, and a region for forming the scanning lines 126 and the signal lines 125 are referred to as a “pixel region”, a “element region”, and a “wiring region”, respectively.

In this embodiment, each of the TFTs 130 has a reversed-staggered structure in which a gate electrode 112, a gate insulating film 113, semiconductor layers 114 and 115, a source electrode 116 and a drain electrode 117 are formed in order from the bottom on the substrate 111 as the body. Namely, the gate electrode 112 is formed by partially extending the corresponding scanning line 126, and the island-like semiconductor layer 114 is formed on the gate insulating layer 113, which covers the gate electrode 112, so as to cross over the gate electrode 112 in a plan view. Also, the source electrode 116 is formed at one of both ends of the semiconductor layer 114 through the semiconductor layer 115, and the drain electrode 117 is formed at the other end through the semiconductor layer 115.

Besides glass, a synthetic resin such as polyvinyl chloride, polyester, polyethylene terephthalate, or the like, a natural resin, or the like can be used for the substrate 111. Alternatively, an insulating layer may be provided on a conductive substrate comprising a stainless steel sheet or the like, and various wirings and elements may be formed on the insulating layer.

Each of the gate electrodes 112 is composed of a metal such as aluminum (Al), molybdenum (Mo), tungsten (W), tantalum (Ta), titanium (Ti), copper (Cu), chromium (Cr), or the like, or an alloy containing at least one of these metals, such as Mo-W, or the like. As shown in FIG. 1, the gate electrodes 112 are formed integrally with the scanning lines 126 arranged in the row direction.

The gate insulating film 113 comprises a silicon-based insulating film composed of silicon oxide (SiOₓ), silicon nitride (SiN_{y}), or the like, and is formed over the entire surface of the substrate 111 to cover the scanning lines 126 and the gate electrodes 112.

The semiconductor layer 114 is an i-type semiconductor layer composed of amorphous silicon (a-Si) undoped with an impurity, or the like, and has a channel region facing each of the gate electrodes 112 through the gate insulating layer 113.

Each of the source electrode 116 and the drain electrode 117 is composed of a metal such as Al, Mo, W, Ta, Ti, Cu, Cr, or the like, or an alloy containing at least one of these metals, and both electrodes 116 and 117 are formed on the i-type semiconductor layer 114 so as to oppose to each other with the channel region provided therebetween. The source electrodes 116 are formed by extending the signal lines 125 disposed in the line direction. Furthermore, as shown in FIG. 1, each of the drain electrodes 117 has an extension 117a extending from a portion positioned above the gate electrode 112 to the scanning line side.

In order to achieve good ohmic contacts between the i-type semiconductor layer 114 and the source electrodes 116 and the drain electrodes 117, the n-type semiconductor layer 115 doped with a high concentration of a V-group element such as phosphorus (P) or the like is provided between the i-type semiconductor layer 114 and the electrodes 116 and 117.

Furthermore, insulating layers 118 and 119 are laminated on the substrate 111, and the pixel electrodes (diffusively reflective electrodes) 120 comprising a metal material with high reflectance, such as Al, Ag or the like, are formed on the insulating film 119.

A plurality of the pixel electrodes 120 is formed in a matrix on the organic insulating layer 119. In this embodiment, the pixel electrodes 120 are formed in one-to-one correspondence to the regions divided by the scanning lines 126 and the signal lines 125. The pixel electrodes 120 are disposed so that the edges thereof are parallel to the scanning lines 126 and the signal lines 125, and substantially all regions of the substrate 111 except the regions for the TFTs 130, the scanning lines 126 and the signal lines 125 are included in the pixel region.

An insulating layer has a two-layer structure comprising the inorganic insulating layer 118 comprising a silicon-based insulating film of silicon nitride (SiN_{y}) or the like, and the organic insulating layer 119 comprising an acrylic resin, a polyimide resin, a benzocyclobutene polymer (BCB) or the like, for enhancing the function to protect the TFTs 130. The organic insulating layer 119 is relatively thickly laminated on the substrate 111 to ensure insulation between the pixel electrodes and the TFTs 130 and the wirings 126 and 125, thereby preventing the occurrence of capacity coupling between the pixel electrodes 120 and the TFTs 130. Also, a stepped structure formed on the substrate 111 by the TFTs 130 and the wirings 126 and 125 is planarized by the thick organic insulating layer 119.

Furthermore, two contact holes 121 and 122 are formed in the insulating layers 118 and 119 to be connected to each of the drain electrodes 117, and the pixel electrodes 120 formed on the organic insulating layer 119 are electrically connected to the respective drain electrodes 117 formed below the insulating layer 118 through conductive portions 120a formed in the respective contact holes 121 and 122. The two contact holes 121 and 122 are formed to be connected to the extension 117a of each of the drain electrodes 117 adjacent to the corresponding scanning line 126, and are arranged at the end of each pixel electrode 120 along the corresponding scanning line 126. Therefore, the area of the pixel electrodes 120 masked with a shielding layer 142S, which will be described below, is decreased. In this construction, secured conduction between each the pixel electrodes 120 and the TFT 130 is achieved through the two contact holes 121 and 122. However, one contact hole or three or more contact holes may be formed.

Furthermore, a plurality of recesses is provided in the surface of the organic insulating layer 119 by pressing a transfer mold on the surface of the organic insulating layer 119 corresponding to the positions of the pixel regions. The recesses formed in the surface of the organic insulating layer 119 are provided for imparting predetermined shapes (recesses 120g) to the respective pixel electrodes 120 so that light incident on the liquid crystal panel 100 is partially scattered by the recesses 120g formed in the pixel electrodes 120. As a result, a brighter display can be obtained in a wider observation range.

Each of the recesses 120g has a spherical inner surface so that light incident on each of the pixel electrodes 120 at a predetermined angle (for example, 30°) is diffusively reflected with a substantially symmetrical brightness distribution with a regular reflection angle as a center. Specifically, the inclination angle of the inner surface of each recess 120g is set in the range of −18° to +18°. Also, the pitch of the adjacent recesses 120g is randomly set for preventing the occurrence of moire due to the arrangement of the recesses 120g.

The diameter of each recess 120g is set to 5 μm to 100 μm from the viewpoint of ease of manufacture, and the depth of each recess 120g is set in the range of 0.1 μm to 3 μm. This is because with the recesses 120g having a depth of less than 0.1 μm, the effect of diffusing reflected light cannot be obtained, while with a depth of over 3 μm, the pitch of the recesses 120g must be increased for satisfying the condition of the inclination angles of the inner surfaces, thereby possibly causing moire.

The term “the depth of each recess 120g” means the distance from the surface of a portion of each pixel electrode 120 in which the recess 120g is not formed to the bottom of the recess 120g. The term “the pitch of the adjacent recesses 120g” means the center-to-center distance between the recesses 120g each having a circular planar shape. The term “the inclination angle of the inner surface of each recess 120g ” means the angle θg of an inclined surface with the horizontal surface (the surface of the substrate 111) within a micro region of 0.5 μm wide at any desired position on the inner surface of each recess 120g, as shown in FIG. 5. The positive and negative angles θg are defined as angles of surfaces inclined to the right side and left side, respectively, of a normal to the surface of a portion of each pixel electrode 120 in which the recess 120g is not formed, for example, as shown in FIG. 5.

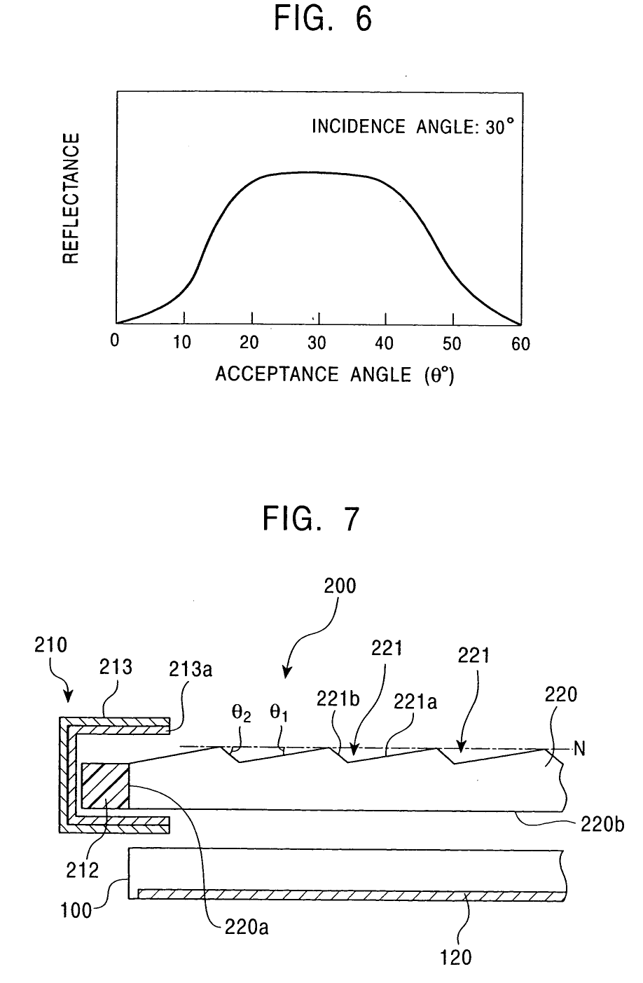

FIG. 6 is a diagram showing the reflection characteristic of the pixel electrodes 120 having the above construction. This figure shows the relationship between the acceptance angle θ and brightness (reflectance) of external light incident on the substrate surface S at an incidence angle of 30°, with a visual angle raging from 0°(perpendicular position) to 60° with respect to the normal direction to the substrate surface S with the regular reflection direction at 30° as a center. In this embodiment, each of the pixel electrodes 120 produces substantially constant reflected light within a range of reflection angles of ±10° with the regular reflection direction at a reflection angle of 30° as a center so that a uniform bright display can be obtained within this range.

Furthermore, an alignment film 123 composing polyimide or the like and subjected to an orientation treatment such as rubbing or the like is formed on the substrate 111 having the above-described construction so as to cover the pixel electrodes 120 and the organic insulating layer 119.

On the other hand, the counter substrate 140 is formed as a color filter array substrate comprising the color filter layer 142 shown in FIG. 2, the color filter layer 142 being formed on a light-transmitting substrate body 141 made of glass or plastic.

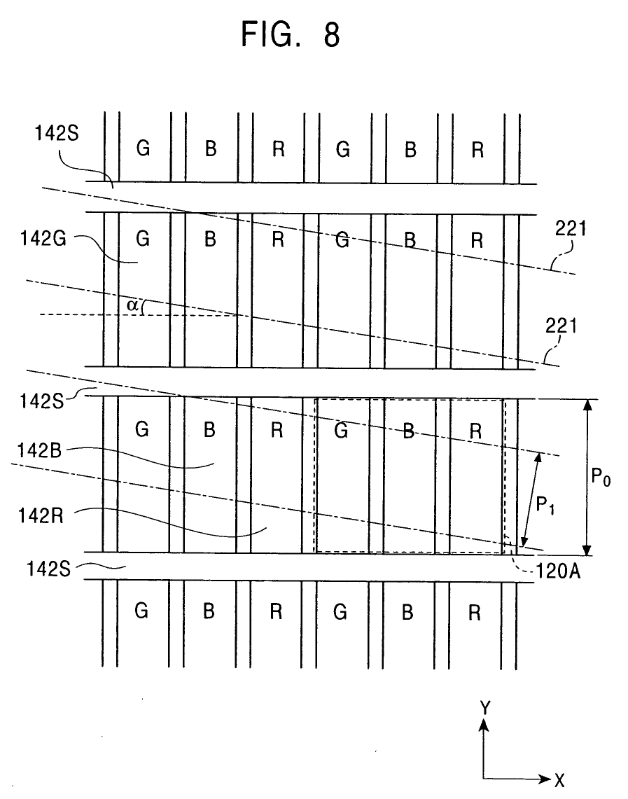

As shown in FIG. 8, the color filter layer 142 comprises color filters 142R, 142G and 142B which are periodically arranged to transmit lights at the wavelengths of red (R), green (G) and blue (B), respectively. The color filters 142R, 142G and 142B are provided at positions corresponding to the respective pixel electrodes 120.

In the color filter layer 142, a shielding layer 142S is formed in regions in which the color filters 142R, 142G and 142B are not formed. As shown in FIG. 1, in a plan view, the light shielding layer 142S is formed in stripes to cover the upper ends of the pixel electrodes 120 where the contact holes 121 and 122 are disposed, such that the upper ends of the pixel electrodes 120 are shielded from light scattered by the conductive layers 120a of the contact holes 121 and 122.

Furthermore, a transparent counter electrode (common electrode) 143 comprising ITO or IZO is formed on the color filter layer 142, and an alignment film 144 comprising a polyimide or the like and subjected to a predetermined orientation treatment is formed on at least a portion of the counter substrate 140 corresponding to the display region.

The substrates 110 and 140 each having the above-described construction are maintained with a predetermined space therebetween through a spacer (not shown in the drawing), and both substrates are bonded together with a thermosetting sealing material (not shown in the drawing) coated in a rectangular shape in the periphery of each substrate. Furthermore, a liquid crystal is sealed in the space closed with the substrates 110 and 140 and the sealing material (not shown in the drawing) to form the liquid crystal layer 150 serving as the light modulating layer. In this way, the liquid crystal panel 100 is formed.

As shown in FIG. 3, the front light 200 comprises a plate-shaped light guide 220 provided opposite to the liquid crystal panel 100 and comprising an acrylic resin transparent member, a quadrangular prism-shaped intermediate light guide 212 disposed on the side end surface of the light guide 220 and comprising an acrylic resin transparent member, and a light emitting element 211 disposed at an end of the intermediate light guide 212 in the longitudinal direction thereof and comprising a LED (Light Emitting Diode) or the like.

The intermediate light guide 212 is disposed in substantially parallel to the light guide 220 through an air layer so that light shallowly incident on the interface between the air layer and the light guide 212 is totally reflected and propagated through the light guide 212. Also, a wedge-shaped groove (not shown in the drawing) is formed in the surface of the intermediate light guide 212 away from the light guide 220, for emitting the light propagated through the intermediate light guide 212 to the light guide 220, a metal thin film of Al or Ag having high reflectivity being formed in the groove.

As shown in FIG. 7, the light guide 220 is disposed in substantially parallel to the display plane of the liquid crystal panel 100 through an air layer. The side end surface facing the intermediate light guide 212 is a light incidence plane 220a, and the surface (lower surface) facing the liquid crystal panel 100 is a light emission plane 220b. Also, prism-shaped grooves 221 are formed in stripes in the upper surface (opposite to the liquid crystal panel 100) of the light guide 220, for epi-illumination of light incident on the incidence plane 220a toward the emission plane 220b.

As shown in FIG. 7, each of the grooves 221 has a wedge shape comprising a pair of inclined surfaces 221a and 221b, the angle θ₁ of the gentle inclined surface 221a with respect to a reference plane N being set, for example, in the range of 1° to 10°. This is because with the angle θ₁ of, for example, less than 1°, the average brightness of the front light 200 decreases, while with the angle θ₁ of over 10°, the quantity of emitted light becomes nonuniform within the emission plane 220b. The angle θ₂ of the steep inclined surface 221a with respect to the reference plane N is set, for example, in the range of 41° to 45°, for decreasing a deviation of the propagation direction of light reflected by each steep inclined surface 221b from the normal direction of the emission plane 220b.

Also, the steep inclined surfaces 221b of the grooves 221 are formed so that the width (perpendicular to the extension direction of the grooves 221) gradually increases in the direction away from the incidence plane 220a, to increase the quantity of light emitted from a position away from the incidence plane 220a because the quantity of light tends to decrease at this point. In a specified example, assuming that the width of the steep inclined surface 221b of the groove 221 closest to the incidence plane 220a is 1.0, the width of the steep inclined surface 221b of the groove 221 most apart (i.e., near the end surface of the light guide 220 away from the incidence plane 220a) from the incidence plane 220a is set to 1.1 to 1.5.

Furthermore, as shown in FIG. 8, the extension direction of the grooves 221 is inclined at a predetermined angle a with respect to the arrangement direction (x-axis direction) of the pixels 120A of the liquid crystal panel 100 so as to prevent the occurrence of moire due to interference between the grooves 221 and the pixels 120A. The inclination angle α is set in the range of 0° to 15°, and preferably in the range of 6.5° to 8.5°. Also, the pitch P₁ of the grooves 221 is smaller than the pixel pitch P₀ so that illumination irregularity with a period corresponding to the pitch P₁ of the grooves 221 is leveled within the pixels 120A, thereby preventing the irregularity from being observed by an observer. Particularly, the pitch P₁ of the grooves 221 and the pixel pitch P₀ preferably satisfy the relationship 0.5P₀<P₁<0.75P₀.

As shown in FIGS. 3 and 7, the intermediate light guide 212 and the light guide 220 are preferably integrally fixed by a case-shaped housing 213 in which a metal thin film 213a of Al or Ag with high reflectance is formed on the inner surface.

Therefore, in the reflective liquid crystal display device of this embodiment, in a plan view, the contact holes 121 and 122 are masked with the shielding layer 142S, and thus the occurrence of moire due to the arrangement of the contact holes 121 and 122 can be prevented. Particularly, in a reflective display device using the diffusively reflective electrodes 120, light is greatly scattered by the recesses 120g of the pixel electrodes 120 formed near the contact holes 121 and 122 to cause the probability that strong moire is observed. However, such scattered light can be cut off by the shielding layer 142S to obtain a high-quality display without remarked moire.

Also, the contact holes 121 and 122 are formed in the extensions 117a disposed near the scanning lines 126, and thus the area of the pixel electrodes 120 masked with the shielding layer 142S can be decreased. Consequently, the aperture ratio can be increased to achieve a bright display. In this case, only the extensions 117a are disposed near the scanning lines 126, and thus electrical characteristics less deteriorate due to capacity coupling between the drain electrodes 117 and the scanning lines 126.

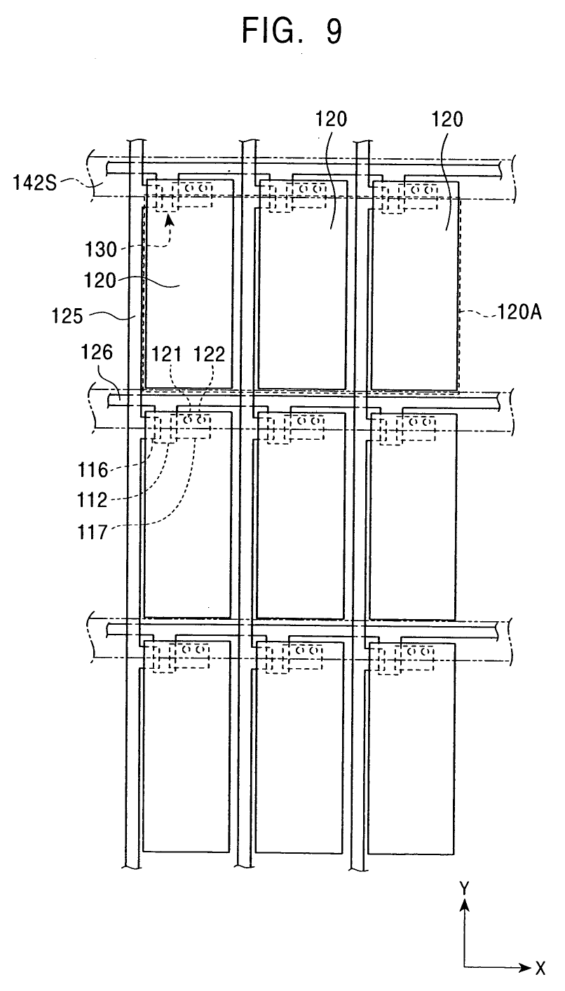

Next, a first modified embodiment of the present invention will be described with reference to FIG. 9.

Unlike in the above embodiment, in an active matrix display device according to this modified embodiment, a drain electrode 117 of each TFT 130 has a rectangular shape. Since the other components are the same as in the above-described embodiment, the description thereof is omitted.

Like in the above embodiment, even in this modified embodiment, therefore, a high-quality display without remarked moire can be achieved.

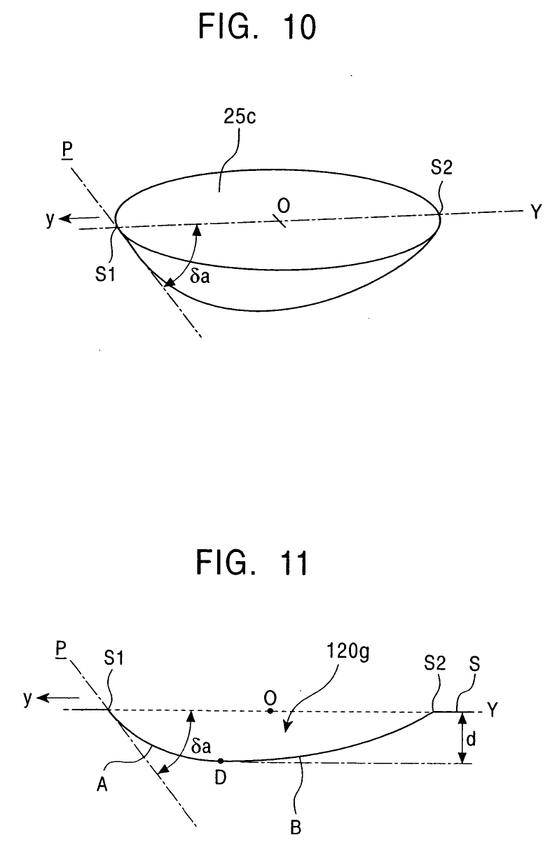

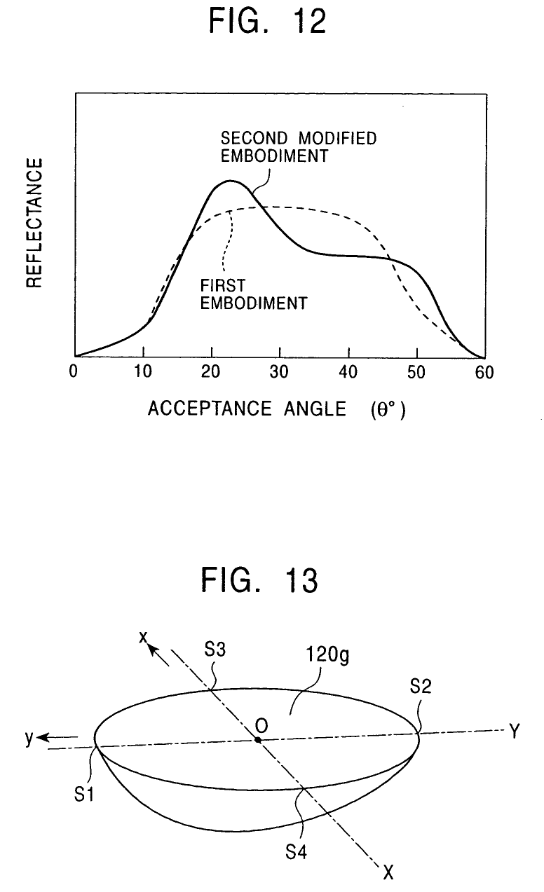

Next, a second modified embodiment of the present invention will be described with reference to FIGS. 10 to 12. FIG. 10 is a perspective view showing a recess formed in each pixel electrode of a liquid crystal panel according to this modified embodiment, FIG. 11 is a sectional view of the recess taken along line Y parallel to the y axis, and FIG. 12 is a diagram showing the reflection characteristic of the recess.

In the active matrix display device of this modified embodiment, the shape of the inner surface of the recess 120g of each pixel electrode 120 in the liquid crystal panel 100 according to the above embodiment is changed so that light incident on each pixel electrode 120 at a predetermined angle (for example, 30°) is diffusively reflected with an asymmetrical brightness distribution with the angle of regular reflection as a center.

Specifically, in this modified embodiment, each of the recesses 120g comprises a first curved surface with a small curvature, and a second curved surface with a large curvature, and the first and second curved surfaces have a first curve A and second curve B, respectively, in a Y section of FIG. 11. The first curve A extends from one S1 of the peripheral edges of each recess 120g to the deepest point D, and the second curve B gently continues from the first curve A and extends from the deepest point D of each recess 120g to the other peripheral edge S2.

The deepest point D deviates from the center O of each recess 120g to the y-direction side, and the inclination angles of the first and second curves A and B with respect to the horizontal plane of the substrate 111 irregularly vary in the range of 1° to 89° and the range of 0.50 to 88° in absolute value, respectively. Therefore, the average inclination angle of the first curve A is larger than that of the second curve B. Furthermore, the maximum inclination angles δa of the first curves A at the peripheral edges S1 of the recesses 120g irregularly vary in the range of 4° to 35°. As a result, the depths d of the recesses 120g irregularly vary in the range of 0.25 μm to 3 μm.

FIG. 12 is a diagram showing the reflection characteristic of each pixel electrode 120 having the above construction. This figure shows the relationship between the acceptance angle θ and brightness (reflectance) of external light incident on the substrate surface S from the y-direction side at an incidence angle 30°, with a visual angle ranging from 0° (perpendicular position) to 60° with respect to a normal direction to the substrate surface S with the regular reflection direction at 30° with respect to the substrate surface S as a center. In FIG. 12, for a comparison, the relation (refer to FIG. 6) between the acceptance angle and reflectance of the pixel electrode 120 having the spherical recess 120g used in the above-described embodiment is shown by a dotted line.

As shown in FIG. 12, in the pixel electrode 120 of this modified embodiment, light incident on the liquid crystal panel at an angle of 30° from the y-direction side is reflected with higher brightness than that in the first embodiment at an angle (about 20°) smaller than the reflection angle of 30° in the regular reflection direction, and conversely, the brightness is smaller than that in the first embodiment at an angle (about 40°) larger than the reflection angle 30°. Namely, the deepest point D of each recess 120g deviates from its center O to the y-direction side, and thus the ratio of light reflected by the second curve B is greater than that reflected by the first curve A, thereby making a brighter reflective display on the y-direction side.

The other components are the same as in the first embodiment, and thus the description thereof is omitted.

Therefore, even in the modified embodiment, the same effect as in the first embodiment can be obtained, and a display brightness in a specified observation direction can be increased to permit the effective utilization of reflected light because the first and second curved surfaces, which constitute the recess 120g of each pixel electrode 120, are formed to be asymmetrical with respect to the deepest point D.

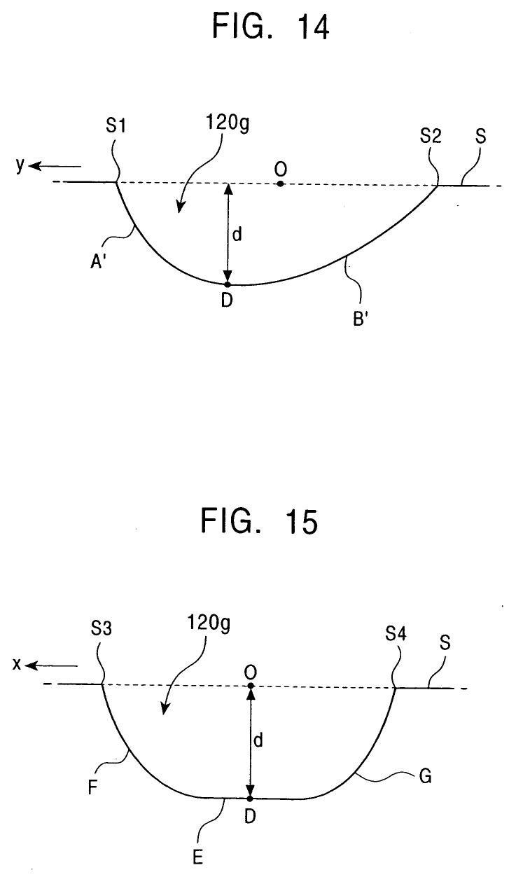

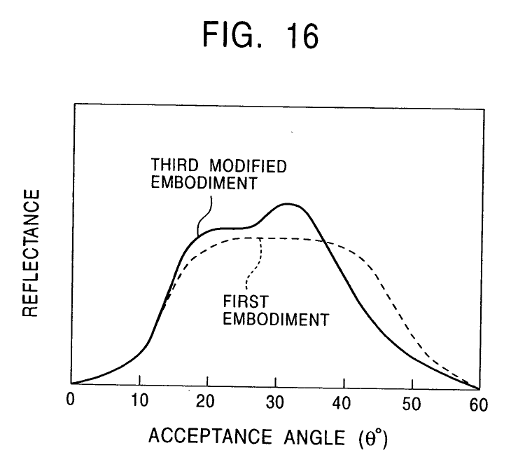

Next, a third modified embodiment of the present invention will be described with reference to FIGS. 13 to 16. FIG. 13 is a perspective view showing a recess formed in a pixel electrode of a liquid crystal panel according to this modified embodiment, FIGS. 14 and 15 are sectional views of the recess taken along planes parallel to the y axis and x axis, respectively, and FIG. 16 is a diagram showing the reflection characteristic of the recess.

Like in the first modified embodiment, in the active matrix display device of this modified embodiment, the shape of the inner surface of the recess 120g of each pixel electrode 120 in the liquid crystal panel 100 according to the first embodiment is changed to impart directivity to reflected light.

Furthermore, like in the second modified embodiment, in this modified embodiment, each of the recesses 120g comprises a first curved surface with a small curvature, and a second curved surface with a large curvature, and the first and second curved surfaces have a first curve A′ and second curve B′, respectively, in a Y section of FIG. 14. The first curve A′ extends from one S1 of the peripheral edges of each recess 120g to the deepest point D, and the second curve B′ gently continues from the first curve A′ and extends from the deepest point D of each recess 120g to the other peripheral edge S2.

The deepest point D deviates from the center O of each recess 120g to the y-direction side, and the inclination angles of the first and second curves A′ and B′ with respect to the substrate surface S irregularly vary in the range of 2° to 90° and the range of 1° to 89° in absolute value, respectively. Therefore, the average inclination angle of the first curve A′ is larger than that of the second curve B′. Furthermore, the maximum inclination angles δa of the first curves A′ at the peripheral edges S1 of the recesses 120g irregularly vary in the range of 4° to 35°. As a result, the depths d of the recesses 120g irregularly vary in the range of 0.25 μm to 3 μm.

On the other hand, in a X-section of FIG. 15, the first curved surface and second curved surface have a substantially symmetrical shape with the center O. The X-sectional shape has a curve E having a larger curvature (i.e., a gentle curve close to a linear line) near the deepest point D, the curve E having an inclination angle of 10° or less in absolute value with respect to the substrate surface S. Also, the inclination angles of the steep curves F and G irregularly vary, for example, in the range of 2° to 9° in absolute value with respect to the substrate surface S. Furthermore, the depths d of the deepest points D of the recesses 120g irregularly vary in the range of 0.1 μm to 3 μm.

FIG. 16 is a diagram showing the reflection characteristic of each pixel electrode 120 having the above construction. This figure shows the relationship between the acceptance angle θ and brightness (reflectance) of external light incident on the substrate surface S from the y-direction side at an incidence angle 30°, with a visual angle ranging from 0° (perpendicular position) to 60° with respect to a normal direction to the substrate surface S with the regular reflection direction at 30° to the substrate surface S as a center. In FIG. 16, for a comparison, the relation (refer to FIG. 6) between the acceptance angle and reflectance of the pixel electrode 120 having the spherical recess 120g used in the above-described embodiment is shown by a dotted line.

In the pixel electrode 120 of this modified embodiment, light incident on the liquid crystal panel at an angle of 30° from the y-direction side is reflected with higher brightness than that in the first embodiment at an angle (about 20°) smaller than the reflection angle of 30° in the regular reflection direction. Namely, the deepest point D of each recess 120g deviates from its center O to the y-direction side, and thus the ratio of light reflected by the second curve B′ is greater than that reflected by the first curve A′, thereby making a brighter reflective display on the side opposite to the y-direction side. Also, a portion near the deepest point D of each recess 120g is formed in a gentle curved surface to increase the reflectance in the regular reflection direction.

The other components are the same as in the first embodiment, and thus the description thereof is omitted.

Therefore, even in this modified embodiment, the same effect as in the first embodiment can be obtained, and display brightness in a specified observation direction can be increased to permit the effective utilization of reflected light.

The present invention is not limited to the above-described embodiments, and various modifications can be made within the scope of the gist of the present invention.

For example, the TFTs 130 are not limited to the reversed staggered structure, and normal staggered TFTs may be used. Also, the switching elements are not limited to TFTs, and MIM (Metal Insulator Metal) structure diodes each comprising an insulating layer held between metal layers may be used.

Furthermore, the contact holes may be formed in the extension direction of the signal lines, not in the extension direction of the scanning lines. In this case, the contact holes are masked by a masking means along the signal lines in a plan view.

Furthermore, the substrate on which the color filter layer 142 is formed is not limited to the counter substrate 140, and the color filter layer 142 may be provided on the active matrix substrate 110. Accordingly, the shielding layer 142S is formed on one of the active matrix substrate 110 and the counter substrate 140. Of course, the shielding layer 142S may be provided on one of the substrates, and the color filters 142R, 142G and 142B may be formed on the other substrate.

Although, in each of the above embodiments, the shielding layer 142S is formed in stripes, the shielding layer 142S may be formed in a lattice shape to surround the color filters 142R, 142G and 142B or may be formed as dots at positions corresponding to the respective contact holes 121 and 122.

In each of the above embodiments, the reflective liquid crystal display device is described as an example of the active matrix display device. However, for example, in the construction of each of the embodiments, a so-called transflective liquid crystal display device may be formed, in which each of the diffusively reflective electrodes 120 comprises a thick film of 80 nm or more in thickness, and an aperture is provided at the center of the electrode 120 (with an aperture ratio of about 10% to 30% of the pixel area).

As described in detail above, according to the present invention, contact holes are masked in a plan view, and thus the occurrence of moire due to the arrangement of the contact holes can be prevented. Particularly, in a reflective display device comprising as diffusively reflective electrodes as pixel electrodes, visibility is possibly significantly deteriorated by moire due to great scattering in the contact holes. However, as described above, light reflected from the contact holes is cut off to obtain a high-quality display without moire.

Also, a pixel electrode is electrically connected to a switching element through a plurality of contact holes to decrease contact resistance between the pixel electrode and the switching element. Furthermore, even if a contact defect occurs between the pixel electrode and the switching element in one of the contact holes, conduction can be achieved through the other contact holes to improve production yield.

In this case, a plurality of contact holes is arranged along the length direction of scanning lines. Therefore, for example, when the contact holes are masked with a shielding layer or the like provided along the scanning lines in a plan view, the area of the pixel electrode masked with the shielding layer is smaller than that in a case in which the contact holes are arranged perpendicularly to the scanning lines, thereby increasing the aperture ratio.

Furthermore, the switching element comprises a thin film transistor, and a drain electrode has an extension extending from a portion of the drain electrode, which is positioned above a gate electrode, to the scanning line side so that the contact holes are connected to the extension. Thus, for example, when the contact holes are masked with a shielding layer or the like provided along the scanning lines in a plan view, the area of the pixel electrodes masked with the shielding layer can be decreased to increase the aperture ratio. In this case, since only the extensions are disposed near the scanning lines, electrical characteristics less deteriorate due to capacity coupling between the drain electrodes and the scanning lines.

What is claimed is:

1. An active matrix display device comprising:
an active matrix substrate comprising a plurality of scanning lines, a plurality of signal lines intersecting the scanning lines, switching elements provided near the respective intersections of the scanning lines and the signal lines, an insulating layer covering the scanning lines, the signal lines, and the switching elements and having contact holes connected to the switching elements, and pixel electrodes electrically connected to the respective switching elements through the contact holes formed in the insulating layer;
a counter substrate having a counter electrode facing the pixel electrodes; and
a light modulating layer held between the active matrix substrate and the counter substrate;
wherein the contact holes are masked in a plan view.

2. An active matrix display device according to claim 1, wherein each of the pixel electrodes is a diffusively reflective electrode.

3. An active matrix display device according to claim 2, wherein the insulating layer has light diffusion recesses, and each diffusively reflective electrode is disposed in each of the recesses and has a shape conforming to each recess.

4. An active matrix display device according to claim 1, further comprising a shielding layer provided on one of the active matrix substrate and the counter substrate, for masking the contact holes in a plan view.

5. An active matrix display device according to claim 1, further comprising a color filter layer and a shielding layer for masking the contact holes in a plan view, both of which are provided on one of the active matrix substrate and the counter substrate, wherein the color filter layer comprises a plurality of color filters disposed corresponding to the respective pixel electrodes, and the shielding layer is disposed between the adjacent color filters.

6. An active matrix display device according to claim 1, wherein a plurality of the contact holes is arranged in the length direction of the scanning lines or signal lines.

7. An active matrix display device according to claim 1, wherein each of the switching elements comprises a thin film transistor comprising a gate electrode extending from the corresponding scanning line, a gate insulating layer disposed on the gate electrode, a source electrode disposed on the gate insulating layer to extend from the corresponding signal line, and a drain electrode electrically connected to the pixel electrode through the contact holes formed in the gate insulating layer, and wherein the drain electrode has an extension extending from a portion positioned above the gate electrode toward the scanning line side or the signal line side so that the contact holes are connected to the extension.
